(19) United States
(12) Patent Application Publication
(10) Pub. No.: US 2015/0134632 A1
(43) Pub. Date: May 14, 2015

(54) SEARCH METHOD

(71) Applicants: Shahar Golan, Haifa (IL); Omer Barkol, Haifa (IL)

(72) Inventors: Shahar Golan, Haifa (IL); Omer Barkol, Haifa (IL)

(21) Appl. No.: 14/397,737

(22) PCT Filed: Jul. 30, 2012
(86) PCT No.: PCT/US12/48863

§ 371 Date: Oct. 29, 2014

(51) Int. Cl. G06F 17/30

(52) U.S. Cl. CPC G06F 17/30864; G06F 17/3053
USPC 707/706; 707/723

(57) ABSTRACT

Embodiments of the present invention provide methods of generating search results from a data set, the method comprising obtaining first search results based on a first query, the search results comprising a plurality of documents assigning a weight value to one or more documents of the first search results calculating a correlation of terms present in the one or more documents of the search results based at least in part on the assigned weight value and obtaining second search results based on a second query, wherein the second query comprises one or more terms having a highest calculated correlation.

### BACKGROUND

Modern computer networks facilitate storage and access of large amounts of data. For example, many websites (in the wider world), and data-stores (in the enterprise), contain large text corpora which can be accessed via communication networks. Due to the amount of data stored in this way, it is often difficult to locate a specific document, or documents related to a certain subject, etc. Typically, these sites and data-stores provide a search facility, or search engine, to allow a user to search for useful or desired information from the stored text corpora.

However, the provided search engine often has limited functionality and the returned results may not be adequate for a user's needs. More recently, advances have been made in providing more capable search tools which, for example, may include support for personalized searches or context based query enrichment.

While it might be desired to include such functionality in an existing search engine, this may not always be practical. For example, a user may not have control over a remotely provided resource, or it may be difficult to modify a legacy system to include the new functionality.

### BRIEF INTRODUCTION OF THE DRAWINGS

Embodiments of the present invention are further described hereinafter by way of example only with reference to the accompanying drawings, in which:

FIG. 1 illustrates a system suitable for practising embodiments of the invention;

FIG. 2 illustrates a client apparatus for implementing embodiments of the invention;

FIG. 3 illustrates a method of obtaining statistics on a database according to embodiments; and

FIG. 4 illustrates a method of generating search results according to embodiments.

### DETAILED DESCRIPTION OF AN EXAMPLE

Embodiments of the invention provide advanced search functionality locally for accessing a remotely stored corpus of information. One approach to locally implement a more advanced search engine is to download an entire database of the corpus into a local server or server farm, index the documents, and run the improved search on the local copy of the corpus. This approach requires heavy memory resources and requires access to the underlying database behind a provided search engine, which may not always be available. A further complication arises when the corpus is regularly updated, as is often the case in real-world examples, as it then becomes necessary to ensure consistency between the downloaded database and the original copy held remotely.

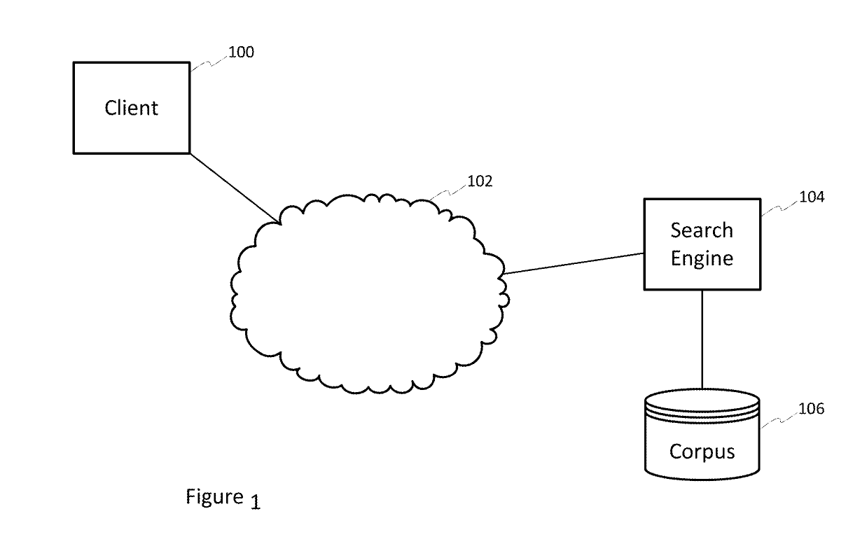

FIG. 1 illustrates a system suitable for implementing embodiments of the invention. The system comprises a client apparatus 100 coupled to a network 102. A search engine 104, which may be provided by a server apparatus (not shown) is also coupled to the network 102, as well as to a database or text corpus of documents. An advanced search module 108 is present on the client apparatus 100, and provides advanced search functionality when performing searches of the corpus 106 via the search engine 104.

The search engine provides search functionality for the contents of the database, returning a list of one or more documents present in the database in response to a search query provided over the network. Thus, to achieve a standard search of the corpus a user submits a search query to client apparatus 100 which passes the query to the search engine 104, via the network 102. The search engine 104 identifies one or more documents relating to the query present in the database 106 and provides the identified documents to the client apparatus 100.

For a search taking advantage of the advanced search functionality, the advanced search module 108 receives the search query submitted by the user and accesses the corpus 106 via the search engine 104 to generate the advanced search results, as will be discussed in greater detail below.

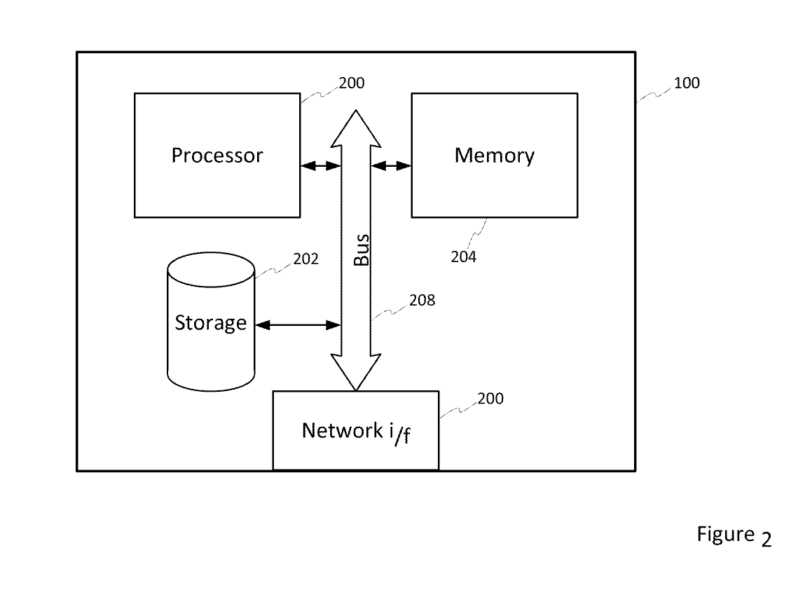

FIG. 2 illustrates a client apparatus that can be used to implement embodiments of the invention. The client apparatus comprises processor 200, a memory 204, storage 202, and a network interface 208. The components of client apparatus 100 are coupled to bus 210 to allow communication between the components and, via the network interface, with the communication network 102. Instructions for advanced search functionality 212 are stored in memory 204, and when executed on the processor 200 these instructions cause the processor 200 to provide the advanced search as described below.

Embodiments of the present invention allow a user to apply more advanced search criteria at the client apparatus 100, such as to allow for personalized search or context based query enrichment, without requiring any change in the functionality of the search engine 104. In particular, a Corpus-Oriented User-Related Search Engine (COURSE) can be simulated at the client apparatus 100 using a standard search engine 104 to access the text corpus 106.

In order to provide the enhanced search capability, some statistics relating to the text corpus should be obtained prior to any searches of the corpus material being made. For example, to understand the relative importance of certain search terms in the context of the corpus, the frequency with which those terms appear in the corpus should be known. Typically, this has been achieved by analyzing the complete corpus to measure the frequencies for terms. However, downloading the whole corpus for analysis may be impractical, particularly in the case of very large remotely stored corpora.

According to embodiments of the invention, a sampling approach is applied to obtain frequency statistics for the appearance of terms in the corpus. By downloading a certain portion of the documents of the corpus, and analyzing the downloading documents, it is possible to estimate term frequencies for terms in the corpus as a whole. For example, one percent of the documents of the corpus may be sufficient to allow frequency statistics for the whole corpus to be estimated. For each term, an inverse document frequency (IDF) can be estimated based on the downloaded documents.

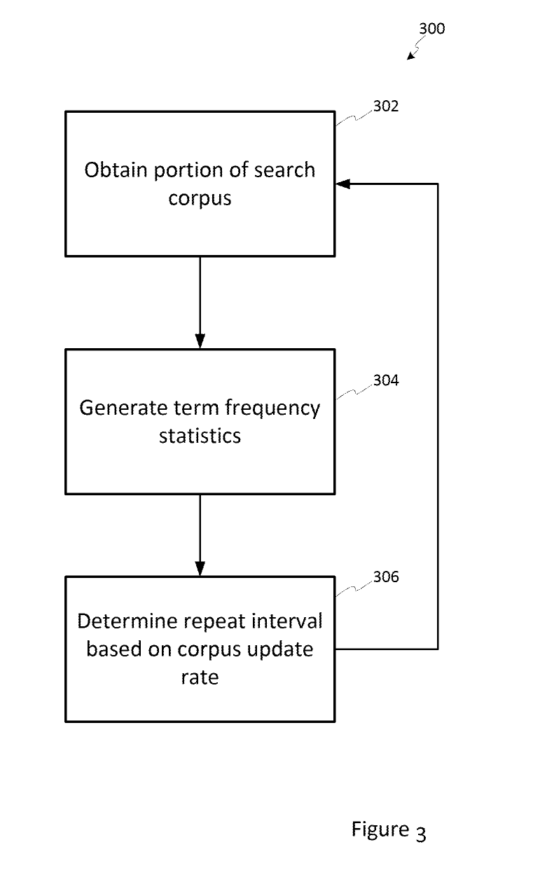

FIG. 3 illustrates a method 300 for estimating term frequency statistics for the text corpus 106. According to the illustrated method, a portion of the text corpus is downloaded to the client apparatus 100 in step 302. For each downloaded document, terms in the document are extracted and compared against the contents of all of the downloaded documents to estimate an IDF for that term at step 304. In order to ensure that the determined statistics remain consistent with the text corpus as it is updated over time; steps 302 and 304 are repeated at regular intervals. This interval may be determined at step 306 based upon an estimate of the rate at which the documents of the corpus are updated.

Using a sampling approach, as outlined above, it is possible that any initially generated statistics may not accurately reflect the contents of the corpus. However, as the steps 302 and 304 are repeated, different portions of the corpus may be considered leading to the generated IDF estimates becoming more accurate over time.

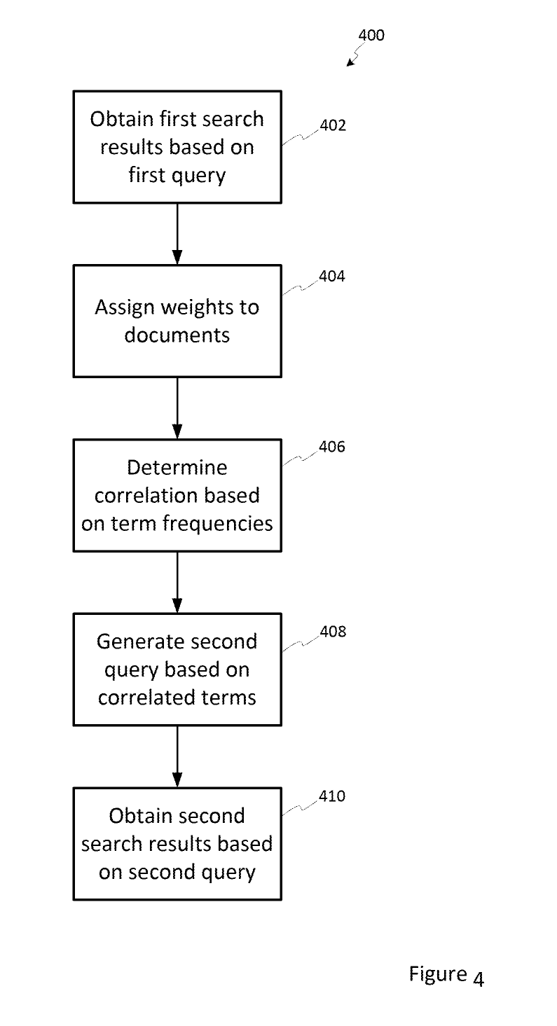

FIG. 4 illustrates a method 400 of simulating a COURSE search on the text corpus 106 accessed using a standard search engine 104. According to the method 400, in a first step 402 a first set of search results are obtained from the search engine 104 based on a search query provided by a user at the client apparatus 100.

Since the client apparatus 100 does not have direct control over the weights of the search terms as applied by the remote search engine 104, the ordering of the search results may be different than desired. More importantly, since only part of the results are examined at the client apparatus 100, the ordering of search results by the search engine 104 may omit some documents considered as important at the client apparatus 100. For this reason, the client apparatus 100 requests more results from the search engine 104 than required for implementing the advanced search. For example, the client apparatus 100 may request four hundred search results, where it is desired only to use the one hundred most relevant.

In step 404 of the method 400, the text content of each document received from the search engine 104 is extracted. Using this information a weight is assigned for each document, taking into account one or more of the following items:
a. The number of search-terms found in the document;
b. Documents written by the person running the search may get an additional boost;
c. The (estimated) frequency of search-terms in the corpus; and
d. The fields that the terms were found in (e.g. title, content).

The received search results are then sorted according to the assigned weight values and a highest weighted portion, for example the top one hundred weighted documents, are taken as a hit list. It is assumed that this hit list does not dramatically change whether four hundred search result documents are received from the search engine 104 or many more. In other words, it is assumed that the most relevant results will also have high probability to be highly ranked by the search engine 104 supplied by the web site or data-store.

In a next step 406, the query is extended based on correlated terms present in the documents of the hit list, i.e. terms present in the documents of the hit list having a high correlation with the terms of the original query are identified to provide a context aware extension of the original search query. A method of identifying highly correlated terms is discussed below.

Let D be the sequence of all documents, ordered by their weight. Let dᵢ be the i^{th} document in D, and wᵢ its weight. Assume that for every document outside the hit list the weight is zero (so w is the weight vector of all documents). For each term tⱼ let δⱼ be a vector or same length, where δᵢⱼ (the i^{th} element in δⱼ) is an indicator whether the j^{th} term appears in the i^{th} document. We now compute the weighted correlation between the term and the set of results:

$$\begin{matrix}Corr ( w , {δ}_{j} ) = \frac{cov ( w , {δ}_{j} )}{{σ}_{w} {σ}_{{δ}_{j}}} \\ = \frac{E ( w {δ}_{j} ) - E ( w ) E ( {δ}_{j} )}{\sqrt{[ E ( {w}^{2} ) - {E}^{2} ( W ) ] [ E ( {δ}_{j}^{2} ) - {E}^{2} ( {δ}_{j} ) ]}} \\ = \frac{{\sum }_{i = 1}^{n} {nw}_{i} {δ}_{ij} - {\sum }_{i = 1}^{n} {w}_{i} {\sum }_{i = 1}^{n} {δ}_{ij}}{\sqrt{[ {\sum }_{i = 1}^{n} {nw}_{i}^{2} - {( {\sum }_{i = 1}^{n} {w}_{i} )}^{2} ] [ {\sum }_{i = 1}^{n} n {δ}_{ij}^{2} - {( {\sum }_{i = 1}^{n} n {δ}_{ij} )}^{2} ]}}\end{matrix}$$

Note that in order to compute the above expression, to determine the weighted correlation between each term and the set of results, we only need the frequency of the term tⱼ, the weights of the documents in the hit list, and δᵢⱼ for the documents in the hit list. The frequencies are assessed using the sampled statistics computed according to method 300 illustrated in FIG. 3. Furthermore, since it is assumed that any documents outside the hit list have zero weight, we only need the frequencies for the computation of Σᵢ₌₁ⁿδᵢⱼ and Σᵢ₌₁ⁿδᵢⱼ².

It should also be noted that a term present in the original query may not necessarily be part of the second, extended, query. Take for example the query “java and class”, and assume “and” is not a stop word. In this case, the word “and” is likely to not be strongly correlated with the top results and thus will not appear in the second query string.

After analysis of the terms present in the documents of the hit list, a number of the most correlated terms are chosen in step 408 to constitute the second, extended, query. For example, the top twenty terms, or all terms having a correlation above a certain threshold value, may be selected.

The second query to the supplied search engine 104, and a second set of search results are obtained from the search engine at step 410.

The second set of search results may then be analyzed to extract the text content and identify terms, and then to assign a weight value to each document as applied to the documents of the first search results in step 404. The same criteria may be used to assign a weight value to the documents of the second search results as are used to assign weights to the documents of the first search results. Thus, a document containing query terms with high correlation will have higher weight. Finally, the results are reranked in order to reflect the weights assigned to the documents according to those parameters.

The reranked documents can then be presented to the user of the client terminal 100 as an output of the context aware search.

According to some embodiments, the search is further personalized to the user. In order to perform personalized search, it is assumed that the identity of the user is known to the system (e.g., by logging in). For a given query, the personal details, e.g. the user name, are added as additional terms to the query; the query is then invoked in the supplied search engine. An alternative method of adding personalized search results is submitting two separate queries: one with the original terms, and the second requiring that the results contain the user name. The result lists from the two queries will be concatenated and weighted as described above.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of generating search results from a data set, the method comprising:
obtaining first search results based on a first query, the search results comprising a plurality of documents;
assigning a weight value to one or more documents of the first search results;
calculating a correlation of terms present in the one or more documents of the search results based at least in part on the assigned weight value; and
obtaining second search results based on a second query, wherein the second query comprises one or more terms having a highest calculated correlation.

2. The method of claim 1, wherein obtaining the first and second search results comprises obtaining the first and second search results from a remote search engine.

3. The method of claim 1 or claim 2, further comprising assigning a weight value to one or more documents of the second search results, and ranking the second search results based on the assigned weight values.

4. The method of any preceding claim, wherein the first search query comprises one or more search query terms provided by a user.

5. The method of any preceding claim, wherein the first search query comprises personal details of a user initiating the search.

6. The method of any preceding claim, wherein assigning a weight value to one or more documents of the search results further comprises assigning a weight value based on one or more of: a number of search-terms of the query present in the document; a frequency of search-terms present in the document compared to a frequency of search terms in the data set; a position of the each search-term in the document; and an author of the document.

7. The method of any preceding claim further comprising estimating a frequency of each of a plurality of terms in the data set.

8. The method of claim 7, wherein estimating a frequency of each of a plurality of terms in the data set further comprises:
obtaining a first portion of the data set, the portion comprising a plurality of documents;
determining an inverse document frequency (IDF) for each of the plurality of terms in the first portion of the data set; and
estimating an inverse document frequency for each term in the data set based on the determined IDF for each term in the first portion of the data set.

9. The method of claim 8, further comprising:
after a predetermined interval, obtaining a further portion of the data set, the further portion comprising a plurality of documents including at least some documents not present in the first portion of the data set;
determining an inverse document frequency (IDF) for each of the plurality of terms in the further portion of the data set; and
estimating an inverse document frequency for each term in the data set based the previously estimated IDF and on the determined IDF for each term in the further portion of the data set.

10. The method of claim 9, further comprising determining a length of the predetermined interval based on an update rate of the data set.

11. The method of any preceding claim further comprising identifying a portion of the first search results having the highest assigned weight values to generate first filtered search results, wherein said calculating a correlation of terms is performed for documents of the first filtered search results.

12. A system comprising:
a processor; and
a memory comprising instructions configured when executed on the processor to cause the system to:
obtain first search results based on a first query, the search results comprising a plurality of documents;
assign a weight value to one or more documents of the first search results;
calculate a correlation of terms present in the one or more documents of the search results based at least in part on the assigned weight value; and
obtain second search results based on a second query, wherein the second query comprises one or more terms present in the one or more documents having a highest calculated correlation.

13. The system of claim 12, further comprising a network interface and wherein the instructions are further configured when executed on the processor to cause the system to obtain the first and second search results via the network interface.

14. The system of claim 12 or claim 13, further comprising a network interface and wherein the instructions are further configured when executed on the processor to cause the system to assign a weight value to one or more documents of the second search results, and ranking the second search results based on the assigned weight values.

15. A computer program product comprising computer program code adapted, when executed on a processor, to perform the steps of any of claims 1 to 11.
